(19) United States
(12) Patent Application Publication
(10) Pub. No.: US 2008/0173255 A1
(43) Pub. Date: Jul. 24, 2008

(54) Electronic Animal Training Apparatus Providing Feedback

(75) Inventors: Christopher E. Mainini, Knoxville, TN (US); Greg Gillis, Escondido, CA (US)

Correspondence Address: PITTS AND BRITTIAN P C, P O BOX 51295, KNOXVILLE, TN, 37950-1295, US

(73) Assignee: Radio Systems Corporation, Knoxville, TN (US)

(21) Appl. No.: 11/624,673

(22) Filed: Jan. 18, 2007

(51) Int. Cl. A01K 15/02

(52) U.S. Cl. 119/720

(57) ABSTRACT

An electronic animal training apparatus with feedback communication, or animal training communicator. The animal training communicator provides feedback to the trainer and the animal using the associated electronics. The animal training communicator includes a base unit accessible to a trainer and a remote unit carried by an animal. The base unit has at least a receiver and the remote unit has at least a transmitter.

### CROSS-REFERENCE TO RELATED APPLICATIONS

Not Applicable

### STATEMENT REGARDING FEDERALLY-SPONSORED RESEARCH OR DEVELOPMENT

Not Applicable

### BACKGROUND OF THE INVENTION

1. Field of Invention

The invention relates to an electronic animal training apparatus. More specifically, this invention relates to an electronic animal training apparatus capable of providing feedback to a trainer.

2. Description of the Related Art

Electronic animal training devices are commonly used to modify the behavior of an animal or to monitor the activity, location, or condition of an animal. Pet owners and professional trainers often use electronic animal training devices to deter an animal from engaging in undesirable behavior. Sportsmen and hunters often use electronic animal training devices to track a sporting dog and determine whether the sporting dog is running or on-point. Many other uses for electronic animal training devices are known.

Presently available animal training devices generally include a transmitter carried by the owner/trainer/sportsman (hereinafter “the trainer”) and a receiver unit worn by the animal. The transmitter is used for issuing commands to the animal. The receiver unit responds to the issued command in a manner dictated by design. For example, the receiver unit may apply a corrective stimulus for training or generate an audible signal that the trainer may follow to locate the animal. The audible signal may vary in tone or frequency to indicate whether the animal is on-point or moving.

With a conventional electronic animal training apparatus, the receiver collar may provide some status information locally at the collar. For example, it is typical to have a visual or audible indicator that identifies when a low battery condition occurs. The visual indicator is typically a light-emitting diode (LED) that illuminates or changes color to indicate status. The typical audible alert is a low volume, periodic beep or chirp intended to attract attention without being obtrusive. Generally, this status information requires close proximity to the animal to allow for visual inspection of the receiver unit or to be within hearing range for the audible alert.

Armed with this basic knowledge about the state-of-the-art for electronic animal training devices, one should appreciate the desirability of improved communication between the trainer and the animal using the associated electronics.

### BRIEF SUMMARY OF THE INVENTION

An electronic animal training apparatus providing feedback, or the animal training communicator, is described herein and illustrated in the accompanying figures. The animal training communicator provides feedback communication between the between the trainer and the animal using the associated electronics. The animal training communicator includes a base unit utilized by a trainer and a remote unit carried by an animal. The base unit includes at least a receiver. The remote unit contains at least a transmitter and a receiver.

Using the animal training communicator, trainers, particularly hunters, receive specific data and feedback about their animals. This feedback is useful in both the training phase and the performance phase (e.g., during the actual hunt). Feedback provides information about the response of the animal to the issued command. For example, sporting dogs necessarily perform many actions outside the sight of the trainer either due to distance or obstructions (e.g., dense vegetation). The animal training communicator of the present invention allows a trainer working with the sporting dog that is running beyond the sight range of the trainer to issue a stop command and to receive feedback about the relative motion of the animal to determine compliance with the command. This feedback is not available with conventional electronic animal training devices.

The remote unit generally includes an antenna, a transmission/reception unit, a processor, one or more sensors, and one or more output devices, which may be specific animal interface devices or more general output devices. The transmission/reception unit receives signals present on the antenna and passes them to the processor for action. Additionally, the transmission/reception unit broadcasts a response via the antenna. An analog-to-digital converter converts analog signals from analog sensors into digital representations that can be used on by the processor.

The delivery rate of the feedback varies based upon the application and design considerations. In one embodiment, the feedback/response occurs substantially in real time. In this embodiment, the remote unit processor initiates continuous or periodic transmission of the feedback signal or responds to continuous or periodic requests from the base unit without requiring interaction on the part of the trainer. One consideration stemming from the use of automatic updates is the impact of transmission times on the battery life of the units but may be useful where the feedback data is changing rapidly. In another embodiment, the data transfer is event driven and data is transmitted when a change in the monitored event occurs or when a threshold is crossed. This embodiment potentially reduces the number of transmissions where the data is not changing rapidly. In a still further embodiment, the feedback data is retrieved on demand, such as when a command or a polling signal is received from the base unit in response to an input from the trainer.

The base unit generally includes an antenna, a transmission/reception unit, a processor, and a human interface device containing one or more controls and/or one or more indicators. The transmission/reception unit receives signals present on the antenna and passes them to the processor for action. Additionally, the transmission/reception unit broadcasts commands and/or responses via the antenna.

The controls of the human interface device generally include at least one button, switch, dial, touch screen, number pad, keyboard, or other interface device that allows a human operator to control the base unit and the remote unit and to issue commands or corrections to the animal carrying the remote unit. The indicators of the human interface device generally include at least one audio output device or visual indication device capable of conveying information to a human operator.

An electronic animal training apparatus providing feedback, or animal training communicator has been briefly summarized and will described in greater detail in the context of the accompanying figures in the Detailed Description of the Invention.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is pictorial representation of the animal training communicator engaging in feedback communication between the trainer and the animal;

FIG. 2 is a block diagram of a general embodiment of the remote unit;

FIG. 3 is a block diagram of a general embodiment of the base unit;

FIG. 4 is a block diagram of a specific embodiment of the remote unit designed to provide feedback about the movement of the animal showing alternative processing techniques; and

FIG. 5 is a flow diagram of the operation of the animal training communicator issuing and confirming compliance with a stop command.

### DETAILED DESCRIPTION OF THE INVENTION

An electronic animal training apparatus providing feedback, or the animal training communicator, is described herein and illustrated in the accompanying figures. The animal training communicator provides feedback communication between the between the trainer and the animal using the associated electronics. The animal training communicator includes a base unit utilized by a trainer and a remote unit carried by an animal. The base unit contains at least a receiver. The remote unit contains at least a transmitter.

Using the animal training communicator, trainers, particularly hunters, receive specific data and feedback about their animals. This feedback is useful in both the training phase and the performance phase (e.g., during the actual hunt). Feedback provides information about the response of the animal to the issued command. For example, sporting dogs necessarily perform many actions outside the sight of the trainer either due to distance or obstructions (e.g., dense vegetation). The animal training communicator of the present invention allows a trainer working with the sporting dog that is running beyond the sight range of the trainer to issue a stop command and to receive feedback about the relative motion of the animal to determine compliance with the command. This feedback is not available with conventional electronic animal training devices.

Available feedback includes other information that is important or useful to the trainer. In this context, the term feedback is not limited to response information but is more generally construed as information that is made available to the trainer by a transmission from the remote unit to the base unit. By way of example, the state of the battery's level is very important. Having the receiver unit stop operating during a session would interrupt the training or put a dog in danger during a hunt. Other examples of useful information include feedback about the dog's heart rate, temperature, level of activity, whether the dog is barking, on point or barking up a tree, and probe contact tension. This list is not intended to be exhaustive of the information available or desirable to the trainer. Any parameter that can be measured, reduced to an electronic representation, and subsequently transmitted to the base unit can be utilized with the present invention.

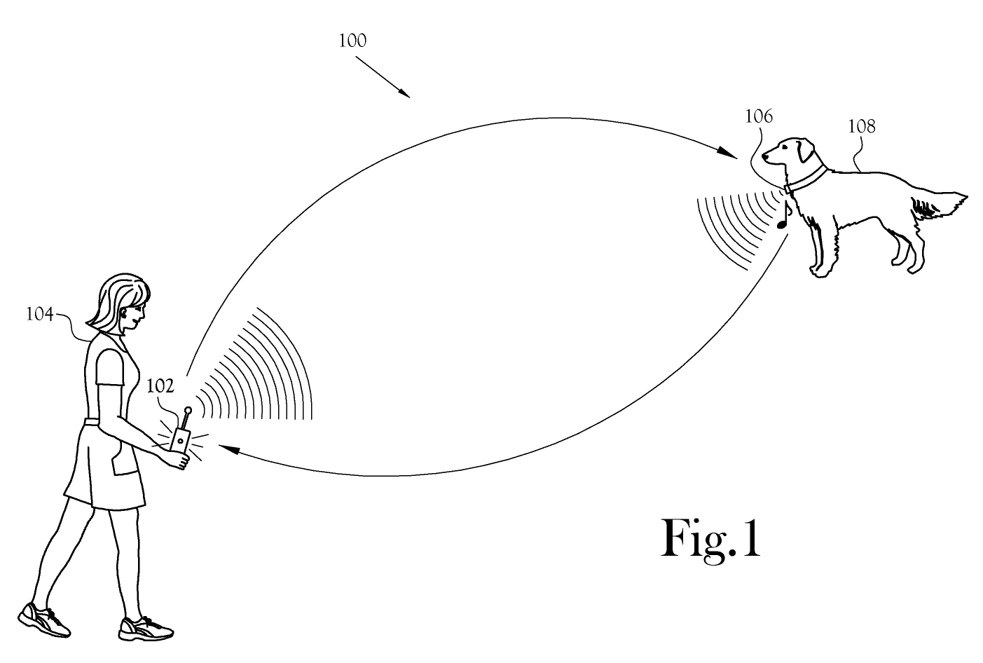

FIG. 1 illustrates the animal training communicator 100 according to the present invention. The animal training communicator 100 includes a base unit 102 utilized by a trainer 104 and a remote unit 106 carried by an animal 108. Although FIG. 1 illustrates the base unit 102 illustrated as a handheld transmitter for portability and use in the field, an alternate embodiment is configured as a stationary transceiver that serves as an information/base station or replaces a conventional electronic animal containment system transmitter. In the illustrated embodiment, a collar 110 allows the animal 108 to carry the remote unit 106. Those skilled in the art will recognize other suitable devices that will allow the animal 108 to carry the remote unit 106 without departing from the scope and spirit of the present invention, such as straps, harnesses, and animal clothing.

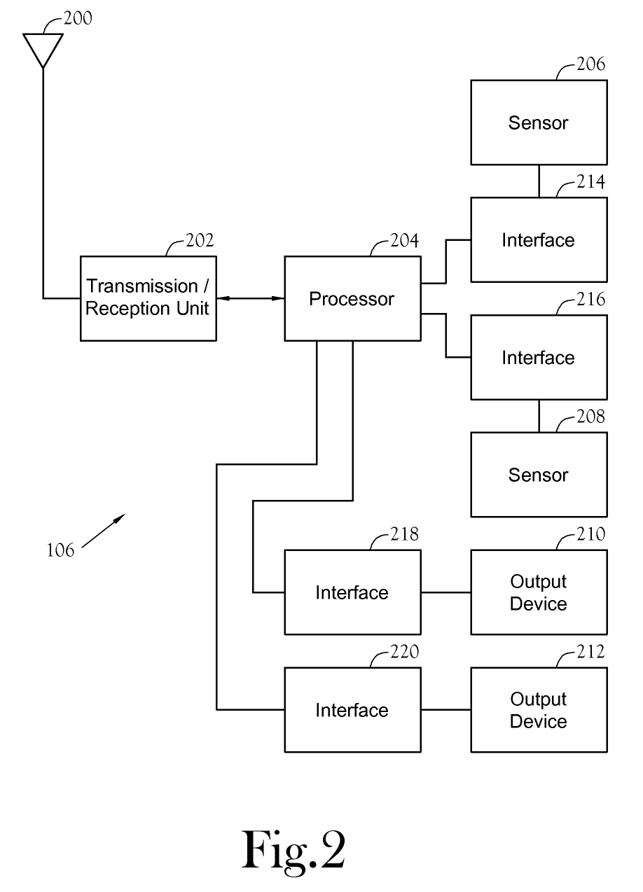

FIG. 2 illustrates a block diagram of one general embodiment of the remote unit 106. The illustrated remote unit 106 includes an antenna 200, a transmission/reception unit 202, a processor 204, one or more sensors 206, 208, and one or more output devices 210, 212, which may be specific animal interface devices or more general output devices. The transmission/reception unit 202 receives signals present on the antenna 200 and passes them to the processor 204 for action. Additionally, the transmission/reception unit 202 broadcasts a response via the antenna 200. The term “animal interface device” and the corresponding term “human interface device” generally refer to any input or output device for receiving an input from or producing an output discernable to the animal or human, respectively. Examples of animal interface devices include vibration sensors, microphones, stimulus generation and delivery circuitry such as electrically conductive probes driven by a transformer, citronella spray devices, and an ultrasonic noise generator producing output at a speaker. General output devices include a human audible noise generator and speaker or a visual indicator and corresponding driver circuitry.

One skilled in the art will appreciate the available processing devices and logic circuits, both analog and digital, which may be used without departing from the scope and spirit of the present invention. One suitable implementation of the controller 202 uses a microcontroller from the PIC16C7X series manufactured by Microchip Technology, Inc., which includes four analog-to-digital converter (ADC) channels. When using the PIC16C7X or a comparable part, the processor 204 receives the signal from the sensor(s) 206, 208, translates it to a digital representation, and analyzes it. In certain embodiments, the digitized signal is passed on to the transmission/reception unit 202 as a direct digital representation of the sensor output. In other embodiments, further processing, analysis, and/or modification of the sensor output is performed to generate an information signal that is sent to the transmission/reception unit 202. The transmission/reception unit 202 then broadcasts the data signal for reception by the base unit 102.

The sensors 206, 208 are unique to the parameter being monitored. Broadly, the sensors are characterized as behavioral sensors for monitoring an activity of the animal, condition sensors for monitoring a condition of the animal or the environment, or status sensors for monitoring a condition of the remote unit. The following list is intended to provide examples of suitable sensors without limiting the types of sensors available for use. For battery life (a status sensor), the battery voltage is measured using a voltage sensor. As the battery voltage drops below a threshold level, a low battery warning is transmitted to the base unit. For barking (a behavioral sensor), vibrations are measured through direct contact vibration sensors such as piezoelectric discs or through indirect transmission sensors such as microphones detecting sound. In addition to or in lieu of issuing a correction, the information that the animal is barking is transmitted to the base unit. For movement (a behavioral sensor), the motion of the animal or lack thereof is measured using an accelerometer or a tilt switch and an indication that the animal is moving or stationary is transmitted to the base unit. For temperature (a condition sensor), the ambient temperature around the animal or the body temperature of the animal is measured using a temperature sensor and transmitted back to the base unit.

In the illustrated embodiment, signal conditioning specific to the parameter being sensed is used to assure that the signal is compatible with the processor 204 used to analyze the information. The necessary signal conditioning is performed by the signal conditioning/interface circuits 214, 216. When a processor without built-in ADC channels is used, the signal conditioning/interface circuit includes an external ADC when necessary or desired. Likewise, an interface between the processor and any specific output device 210, 212 may be necessary.

Remote communication techniques and circuits for achieving remote communication are familiar to one skilled in the art. The specific implementation of the transmission/reception unit depends upon the objectives of the device. The transmission/reception unit contains at least a transmitter and a receiver. In one embodiment, the transmission/reception unit utilizes a separate transmitter and a separate receiver. Separate components permit differing communication types to be used within the single device, for example, the receiver operates using radio frequency communications and the transmitter operates using magnetic field communication. In another embodiment, the transmission/reception unit employs a combination device such as a transponder or a transceiver.

The transmission/reception unit includes ancillary circuitry such as modulators/demodulators, encoders/decoders, and upconverters/downconverters as necessary to implement the communication objectives of the device. The transmitter/reception unit components are selected to utilize the modulation techniques, encryption techniques, information encoding techniques, and broadcast frequencies best suited for the design objectives of the electronic animal training apparatus. Factors influencing the selection of components include, but are not limited to, size, range, sensitivity, reliability, power consumption, noise rejection, and error correction.

The delivery rate of the feedback varies based upon the application and design considerations. In one embodiment, the feedback/response occurs substantially in real time. In this embodiment, the remote unit processor initiates continuous or periodic transmission of the feedback signal or responds to continuous or periodic requests from the base unit without requiring interaction on the part of the trainer. One consideration stemming from the use of automatic updates is the impact of transmission times on the battery life of the units but may be useful where the feedback data is changing rapidly. In another embodiment, the data transfer is event driven and data is transmitted when a change in the monitored event occurs or when a threshold is crossed. This embodiment potentially reduces the number of transmissions where the data is not changing rapidly. In a still further embodiment, the feedback data is retrieved on demand, such as when a command or a polling signal is received from the base unit in response to an input from the trainer.

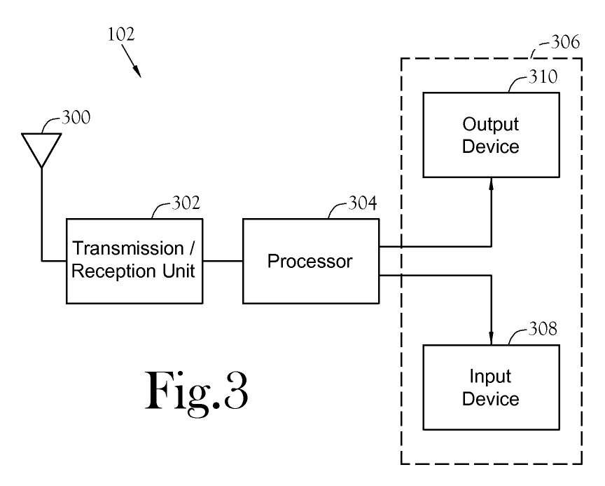

FIG. 3 illustrates a block diagram of one general embodiment of the base unit 102. The illustrated base unit 102 includes an antenna 300, a transmission/reception unit 302, a processor 304, and a human interface device 306 containing one or more controls 308 and/or one or more indicators 310. The transmission/reception unit 302 receives signals present on the antenna 300 and passes them to the processor 304 for action. Additionally, the transmission/reception unit 302 broadcasts commands and/or responses via the antenna 300. The transmission/reception unit 302 follows the same basic design considerations of the remote unit transmission/reception unit discussed with respect to FIG. 2.

In one embodiment, the controls 308 of the human interface device 306 include at least one button, switch, dial, touch screen, number pad, keyboard, or other interface device that allows a human operator to control the base unit and the remote unit and to issue commands or corrections to the animal carrying the remote unit. The indicators 310 of the human interface device 306 include at least one audio output device or visual indication device capable of conveying information to a human operator. Examples of suitable indicators include piezoelectric tone generators, speakers, liquid crystal display screens, light emitting diodes, and lamps. The size, number, and type of components making up the human interface device 306 is influenced by the size, ergonomic layout, and aesthetic design of the base unit and the desired functionality, price point, power consumption, reliability, and other relevant design considerations.

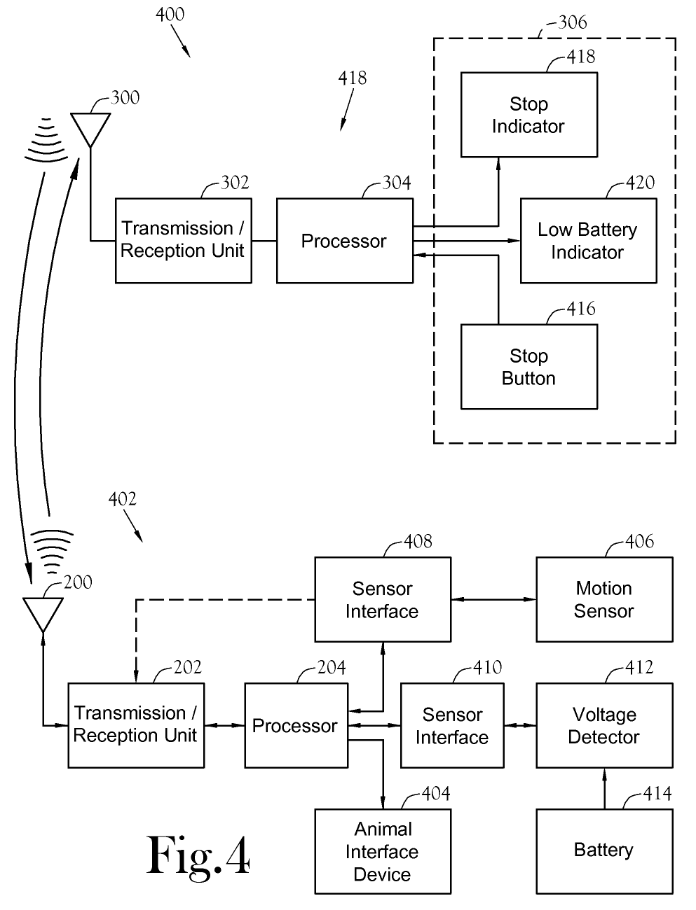

FIG. 4 illustrates one embodiment of an animal training communicator 400 based on the example of issuing the stop command. The remote unit 402 includes an antenna 200, a transmission/reception unit 202, a processor 204, an animal interface device 404, a motion sensor 406 for measuring the animal's movement, and an interface 408 between the motion sensor 406 and the processor 204. The remote unit 402 also includes a voltage measurement circuit 412 in communication with the battery 414. An interface 410 between the voltage measurement circuit 412 and the processor 204 provides the signal conditioning to allow the processor receive an input from the voltage measurement circuit 412. The base unit 418 includes an antenna 300, a transmission/reception unit 302, and a human interface device 306 having at least a stop command button 416 allowing the trainer to communicate a stop command to the animal carrying the remote unit 402, a visual indicator 418 for communicating feedback to the trainer as to whether the animal obeyed the stop command, and a low battery indicator 420. In the example being described the animal interface device 404 is a vibration generator or an animal audible sound generator to communicate the stop command to the animal. For training/correction purposes, the animal interface device further includes an electrical shock generator and delivery mechanism.

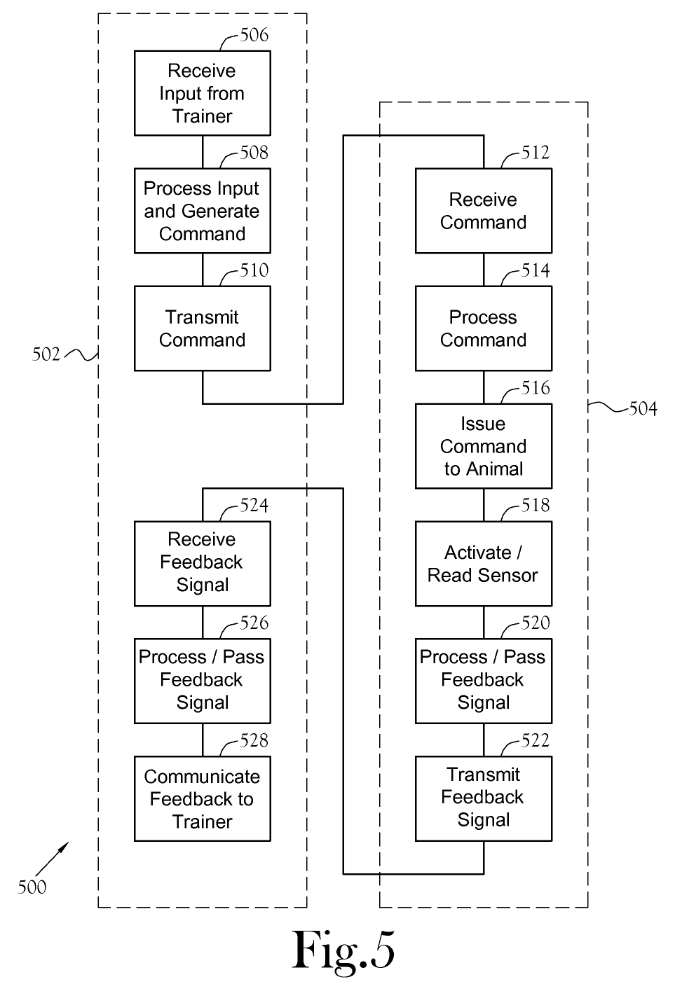

FIG. 5 is a flow diagram 500 illustrating the process of the animal training communicator 400 for the example of issuing the stop command for both the base unit 502 and the remote unit 504. Assume that the animal is moving through an area of dense vegetation and is out of sight of the trainer. The trainer desires the animal to stop moving and presses the stop command button on the base unit 506. The processor receives the input from the stop command button 508 and the base unit then broadcasts a command signal to the remote unit carried by the animal 510. The remote unit receives 512 and processes the command signal 514. The remote unit, through the animal interface device, communicates the command to the animal 516. Upon issuing the command to the animal, the processor reads the output of the motion sensor 518. The processor then passes the motion sensor output as the feedback signal or processes the motion sensor output to produce a feedback signal corresponding to the motion sensor output 520. Next, the remote unit broadcasts the feedback signal to the base unit carried by the trainer 522. The base unit receives 524 and processes 526 the feedback signal. The base unit presents status/feedback information to the trainer through the human interface device 528.

The description of FIG. 5 notes that the feedback signal is either the sensor output or a signal based on the sensor output. Referring back to FIG. 4, in the embodiment where the feedback signal is based on the sensor output, the processor reads and processes the motion sensor output as represented by the object line. The sensor output is evaluated by the processor to determine whether the animal has stopped. The processor then generates a feedback signal containing the results of the motion determination, i.e., whether the animal has stopped or not. The feedback signal is passed to the transmission/reception unit and broadcast to the base unit. The base unit receives the signal and communicates the results to the trainer without substantial additional processing. For example, the base unit changes the illumination of a multi-color light-emitting diode from green to red to indicate the animal is not moving or from red to green to indicate compliance with the command. Alternatively, in the embodiment where the motion sensor output is transmitted without processing, the motion sensor output passes directly to the transmission/reception unit for transmission to the base unit as represented by the broken line.

The specific embodiment described heretofore describes a situation requiring two-way communication. Other embodiments using one-way communication include a bark control device that monitors and corrects the barking of the dog and then sends information about barking episodes, corrections, warnings, volume levels, or other relevant information to a base unit accessible to the trainer. The base unit for this particular bark control application need not have input devices or a transmitter and the remote unit for this particular bark control application does not need a receiver unit. In another embodiment of a one-way communication device, the remote unit monitors the battery level and communicates this information back to the trainer via the base unit but the remote unit does not receive commands from the base unit.

An electronic animal training apparatus with feedback, or animal training communicator, has been described herein in reference to the accompanying figures. The animal training communicator uses a transmission/reception unit in both the base unit accessible to the trainer and the remote unit carried by the animal to provide feedback to the trainer about the animal's activities, condition, or status. The remote unit includes an animal interface device for specifically communicating with the animal and, optionally, includes general output devices for communicating with the animal and/or the trainer. The remote unit further includes sensors that monitor the activity, condition, or status of the animal. The sensors are generally related to the function of the electronic animal training apparatus. In addition to the typical command buttons, the base unit includes output devices for communicating the feedback information to the trainer. The animal training communicator provides the trainer with an increased amount of information and control over a conventional electronic animal training apparatus.

While the present invention has been illustrated by description of several embodiments and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicants general inventive concept.

Having thus described the aforementioned invention, what is claimed is:

1. An electronic animal training apparatus for use by a trainer to communicate with an animal, said electronic animal training apparatus including a base unit accessible to the trainer and a remote unit carried by the animal, said electronic animal training apparatus comprising:
a remote unit sensor producing a sensor output;
a remote unit processor in communication with said remote unit sensor;
a remote unit transmitter in communication with at least one of said remote unit sensor and said remote unit processor, said remote unit transmitter broadcasting a feedback signal based on said sensor output;
a base unit receiver for receiving said feedback signal, said base unit receiver in communication with said base unit processor;
a base unit processor in communication with said base unit input device, said base unit processor for processing said input and generating a command signal; and
a base unit output device in communication with said base unit receiver, said base unit output device producing a notification intelligible to the trainer, said notification based on said feedback signal.

2. The electronic animal training apparatus of claim 1 further comprising:
a base unit input device in communication with said base unit processor, said base unit input device receiving an input from the trainer that is processed by said base unit processor into a command signal;
a base unit transmitter in communication with said base unit processor, said base unit transmitter broadcasting said command signal;
a remote unit receiver receiving said command signal, said command signal being processed into an action signal by said remote unit processor
whereby said transmission of said feedback signal occurs in response to said action signal.

3. The electronic animal training apparatus of claim 2 further comprising a remote unit output device in communication with said remote unit processor, said remote unit output device generating an output discernible by the animal in response to said action signal.

4. The electronic animal training apparatus of claim 1 wherein said remote unit processor generates an action signal in response to said sensor output, said electronic animal training apparatus further comprising a remote unit output device in communication with said remote unit processor, said remote unit output device generating an output discernible by the animal in response to said action signal.

5. The electronic animal training apparatus of claim 1 wherein said remote unit sensor is selected from the group consisting of a behavioral sensor for monitoring an activity of the animal, a condition sensor for monitoring a condition of the animal or the environment, or a status sensor for monitoring a condition of the remote unit.

6. The electronic animal training apparatus of claim 1 wherein said feedback signal is based on said sensor output.

7. The electronic animal training apparatus of claim 1 wherein said remote unit transmitter broadcasts said sensor output as said feedback signal.

8. A method for communicating information in an electronic animal training system including a base unit accessible to the trainer and a remote unit carried by the animal, the base unit including a receiver and the remote unit including a transmitter and sensor, said method comprising the steps of:
(a) sensing at least one of a condition, behavior, or status at the remote unit as a sensor signal;
(b) transmitting an information signal corresponding to said sensor signal from the remote unit;
(c) receiving said information signal at the base unit;
(d) processing said information signal at the base unit to obtain information contained in said information signal; and
(e) presenting said information at the base unit in a format intelligible to the trainer.

9. The method of claim 8 wherein the remote unit also includes a receiver and the base unit also includes a transmitter and an input device, said method further comprising the steps of:
(f) receiving an input at the base unit from the trainer;
(g) processing said input at the base unit to produce a command signal;
(h) transmitting said command signal from the base unit;
(i) receiving said command signal at the remote unit;
(j) processing said command signal at the remote unit to produce action signal;
whereby said step of transmitting an information signal corresponding to said sensor signal occurs in response to said action signal.

10. The method of claim 9 wherein the remote unit also includes an animal interface device, said method further comprising the step of:
(k) delivering an output discernible to the animal at the remote via the animal interface device in response to said action signal.

11. The method of claim 8 wherein the remote unit also includes an animal interface device, said method further comprising the steps of:
(l) generating an action signal in response to said sensor output;
(m) delivering an output discernible to the animal at the remote via the animal interface device in response to said action signal.

12. The method of claim 8 wherein said information signal is based upon said sensor output.

13. The method of claim 8 wherein said information signal is said sensor output.
